(19) United States
(12) Patent Application Publication
(10) Pub. No.: US 2022/0234926 A1
(43) Pub. Date: Jul. 28, 2022

(54) SYSTEM FOR MICROORGANISM BASED TREATMENT OF WASTEWATER

(71) Applicant: Volker A. Hausin, Fairport, NY (US)

(72) Inventor: Volker A. Hausin, Fairport, NY (US)

(21) Appl. No.: 17/156,858

(22) Filed: Jan. 25, 2021

(51) Int. Cl. C02F 3/20; C02F 3/10

(52) U.S. Cl. CPC C02F 3/20; C02F 3/104; C02F 2303/26; C02F 2203/006; C02F 2301/026

(57) ABSTRACT

A bio-reactor for treating wastewater effluent using microorganisms includes a tank having a first volume, a second volume, and a third volume, each volume having an outer wall; an inlet in the first volume to introduce wastewater effluent; a central channel located within the second volume; a first air supply to introduce air into wastewater effluent located in the central channel within the second volume; a packed media bed of small components, the packed media bed being located in the second volume; a second air supply to introduce air into wastewater effluent located in the third volume to assist movement of wastewater effluent upward from the third volume, through the packed media bed, to the first volume; and an outlet in the third volume to drain a portion of the wastewater effluent.

### BACKGROUND

Wastewater treatment facilities, such as municipal, agricultural or industrial wastewater treatment facilities, commonly utilize aeration techniques in order to treat the wastewater. Aeration of the wastewater has been found to reduce or eliminate contaminants found in the wastewater by increasing the oxygen available to microorganisms which break down contaminants during a biological process.

An example of wastewater treatment is disclosed in U.S. Pat. No. 6,231,766. U.S. Pat. No. 6,231,766 discloses disposing a plurality of bio-suspension elements within an enclosure which is at least partially submerged in a body of water, wherein a screen is disposed within the enclosure, wherein the bio-suspension elements provide surfaces for supporting the growth of at least five different biological microorganisms, and wherein the bio-suspension elements are disposed above the screen, introducing the at least five different biological microorganisms into the enclosure along with the water continuously agitating, aerating, and feeding the water into the enclosure, (d) forcing air through the screen, whereby treated water is produced, and continuously removing the treated water from the enclosure. The entire content of U.S. Pat. No. 6,231,766 is hereby incorporated by reference.

Another example of wastewater treatment is disclosed in U.S. Pat. No. 7,101,483. U.S. Pat. No. 7,101,483 discloses a process for treating a body of water in which a bioreactor located in a body of water. Water is passed through the bioreactor that contains a plurality of bio-suspension elements within an enclosure located above a screen. The entire content of U.S. Pat. No. 7,101,483 is hereby incorporated by reference.

A third example of wastewater treatment is disclosed in U.S. Pat. No. 8,372,285. U.S. Pat. No. 8,372,285 discloses a reactor that contains a perforated chimney through which air can flow and optimize dissolving oxygen into the aqueous environment of the various bio-remediation stages. The entire content of U.S. Pat. No. 8,372,285 is hereby incorporated by reference.

In the various conventional wastewater treatment systems described above, the microorganisms used to treat the wastewater are lost during the discharge of the treated water. Moreover, the wastewater treatment process requires a constant seeding of microorganisms that may not be mature enough to effectively process the wastewater.

Therefore, it is desirable to provide a wastewater treatment system that minimizes the loss of mature microorganisms during discharge.

Moreover, it is desirable to provide a wastewater treatment system that reduces the seeding of microorganisms in the treatment process.

In addition, it is desirable to provide a wastewater treatment system that recycles microorganisms in a discharge container back to a first treatment chamber.

### BRIEF DESCRIPTION OF THE DRAWINGS

The drawings are only for purposes of illustrating various embodiments and are not to be construed as limiting, wherein:

FIG. 1 shows an example of a conventional treatment reactor for treating wastewater;

FIG. 2 shows a treatment bio-reactor for treating wastewater;

FIG. 3 illustrates a system of multiple treatment bio-reactors for treating wastewater;

FIG. 4 shows a diversion member for diverting fluid to an outer edge of a non-round treatment bio-reactor container;

FIG. 5 shows a side view of the diversion member of FIG. 4;

FIG. 6 shows a cross section of the diversion member of FIG. 4; and

FIG. 7 shows a diversion member for diverting fluid in a rotational manner along an outer edge of a round treatment bio-reactor container.

### DETAILED DESCRIPTION

For a general understanding, reference is made to the drawings. In the drawings, like references have been used throughout to designate identical or equivalent elements. It is also noted that the drawings may not have been drawn to scale and that certain regions may have been purposely drawn disproportionately so that the features and concepts may be properly illustrated.

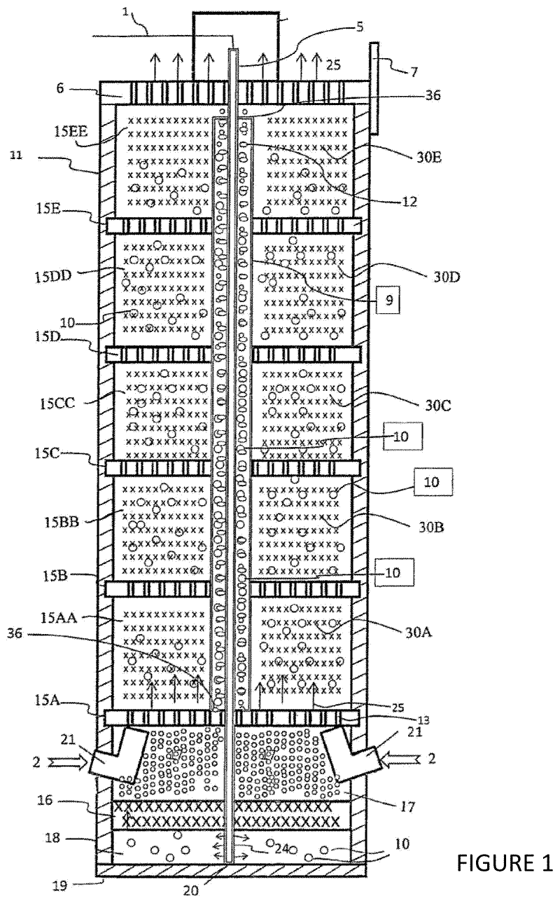

A conventional treatment reactor for treating wastewater is illustrated in FIG. 1. As illustrated in FIG. 1, a reactor R contains solid outer walls 11. The reactor R generally has a bottom chamber 18 that receives air or oxygen-containing gas under a slight pressure. Air is admitted to the reactor R via an air pump, not shown, that supplies air through air supply pipe or conduit 1 and into the top of the reactor through reactor air inlet pipe 5. Air inlet pipe 5 is solid except at the bottom portion thereof that has openings or perforations 24 that admits the pressurized air into air pressure chamber 18. Air inlet pipe 5 is connected to reactor bottom plate 19 through connection 20.

Since the air flowing into chamber 18 is under pressure, the air is forced through micro-porous diffuser 16 that has tiny openings so that the air is admitted into aqueous waste composition chamber 17 in the form of tiny (fine) bubbles 10.

The aqueous waste composition is added to the reactor R through wastewater inlet 21 that can be in the shape of an elbow having an opening at the other end thereof. When placed in a tank containing an aqueous waste composition therein, the aqueous waste composition will flow into aqueous waste composition chamber 17 where it is mixed with air bubbles 10.

The aqueous waste composition will be caused to flow upward through the reactor R via drag forces due to forced air flow through the perforated air carrier pipe, chimney 9.

In other words, the reactor R is a bottom input of air as well as the aqueous waste composition that is then caused to flow upward through various perforated separators 15A, 15B, 15C, 15D, and 15E, which have perforations 13 therein. The size of the various perforated openings in the separators is sufficient to allow air and water to flow therethrough but generally and desirably does not permit the packing substrates 30, to pass therethrough.

Perforated separator 15A is a diffuser that allows bubbles 10 of air in aqueous waste composition 17 to flow upward therethrough (flow arrows 25) thus providing an additional mixing of the aqueous waste composition and the air bubbles so that some of the oxygen in the air is dissolved into the water.

The area formed between perforated separators 15A, 15B, 15C, 15D, and 15E, identified as chamber 15AA, 15BB, 15CC, 15DD, and 15EE. The chambers 15AA, 15BB, 15CC, 15DD, and 15EE are filled with packing substrate 30.

For example, chamber 15AA contains packing substrate 30A that is efficient in mixing the air bubbles and water to dissolve the oxygen within the water. Packing substrate 30A has a high surface area and a high amount of pores.

Located within packing substrate 30A are microorganisms. Microorganisms are utilized so that the reactor R is efficient with regard to eradicating, detoxifying, complexing, or otherwise treating the various different types of waste contained with the aqueous waste composition.

Since bubbles 10 are lighter than the water, the bubbles 10 flow upward through chamber 15AA and cause the aqueous waste composition to flow upward so that continuous mixing of the air and the waste composition occurs, thereby continuously causing dissolving of some of the oxygen into the water.

The upward flow of the aqueous waste composition through the packing substrates 30A causes the dissolved molecular components of the waste composition to eventually contact microorganisms contained within the pores of the substrate whereby the waste composition molecule is bio-remediated. Thus, upon reaching perforated top plate 6 only purified water is discharged.

The reactor R also contains a chimney pipe 9 that has perforations 12 therein. Chimney pipe 9 is located generally in the center of the reactor R such as adjacent to input air pipe 5. As illustrated in FIG. 1, there are two chimney pipes 9 located on either side of air pipe 5 with the chimney pipes 9 being perforated 36 at the bottom thereof and also being perforated 36 at the top thereof at perforated top plate 6.

Accordingly, air bubbles 10 and the aqueous waste composition can enter the bottom of chimney pipe 9 and flow upward through the pipe 9.

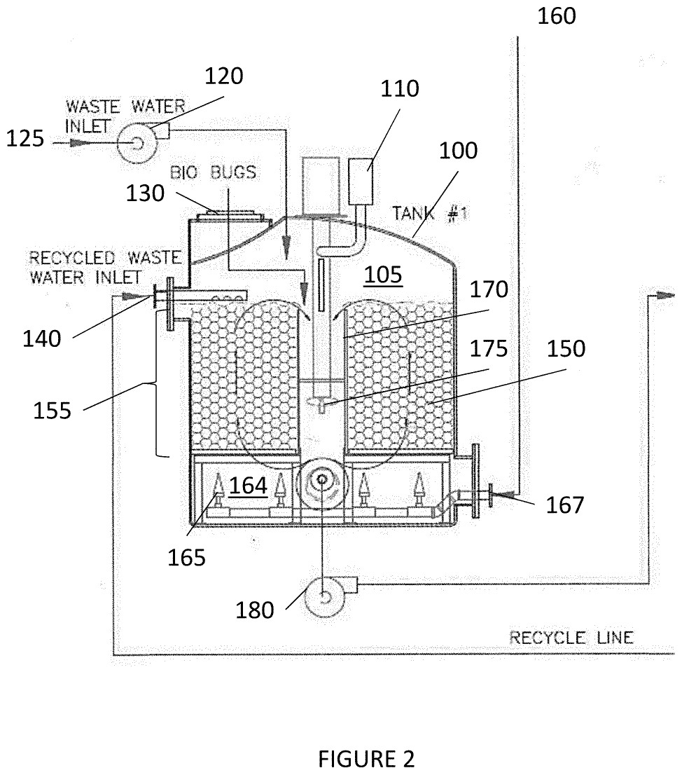

As illustrated in FIG. 2, a treatment bio-reactor for treating wastewater effluent includes a tank 100 that utilizes microorganisms to treat the wastewater. The tank 100 includes a packed media bed 150. The packed media bed 150 is composed of small components, which provide a large surface area for the microorganisms to interact with the wastewater effluent being treated.

The microorganisms can be introduced at an upper volume 105 of the tank 100 through an opening 130. Moreover, fresh wastewater effluent 125 can be introduced in upper volume 105 of the tank 100 via an inlet pump and/or valve 120.

A first air pump 110 provides air to a central volume 170 of the tank 100 so as to introduce bubbles into the wastewater effluent within the central volume 170 of the tank 100.

The central volume 170 of the tank 100 is formed by a non-porous barrier(s) that forms a channel between the upper volume 105 of the tank 100 and a lower volume 164 of the tank 100. The barrier(s) holds the packed media bed 150 of small components in place and channels the wastewater effluent towards the lower volume 164 of the tank 100. The central volume 170 of the tank 100 is open at either end so that wastewater effluent is received at one end and wastewater effluent is discharged at the other end. The central volume 170 and the packed media bed 150 make up a middle volume 155 of the tank 100.

The air from the first air pump 110 may be is forced through a diffuser (not shown) that has openings so that the air is admitted into wastewater effluent within central volume 170 of the tank 100 in the form of bubbles.

The bubbles can be further reduced in size by a propeller device 175 which pushes the wastewater effluent within the central volume 170 of the tank 100 downward into a lower volume 164 of the tank 100.

With respect to the air being pumped by the first air pump 110, the propeller device 175 can also function as an aerator to aerate the wastewater effluent within the central volume 170 of the tank 100 with the air being introduced into the central volume 170 of the tank 100 by the first air pump 110.

The wastewater effluent within the central volume 170 of the tank 100 flows downward into a lower volume 164 of the tank 100 and back up through the packed media bed 150 of small components to create a flow of the wastewater effluent from the upper volume 105 of the tank 100, down through the central volume 170 of the tank 100, into a lower volume 164 of the tank 100, and upward through the packed media bed 150 of small components towards the upper volume 105 of the tank 100.

A second air supply 160 pumps air into the lower volume 164 of the tank 100 via an air inlet 167 and diffusers 165. The diffusers 165 create bubbles to assist in moving the wastewater effluent upward through the packed media bed 150 of small components towards the upper volume 105 of the tank 100.

It is noted that the diffusers 165 may be angled towards the outer wall of the lower volume 164 of the tank 100 to create a flow near the outer wall to prevent or reduce pooling of the wastewater effluent near the outer wall.

In the lower volume 164, a portion of the wastewater effluent can be drained off and pumped by pump 180 to a second tank (not shown).

In addition to the introduction of fresh wastewater effluent 125 into the upper volume 105 of the tank 100, recycled wastewater effluent from another tank is introduced in the upper volume 105 of the tank 100 via a recycled wastewater effluent inlet 140. The recycled wastewater effluent is wastewater effluent which has been processed in another tank having the components discussed above with respect to the tank 100.

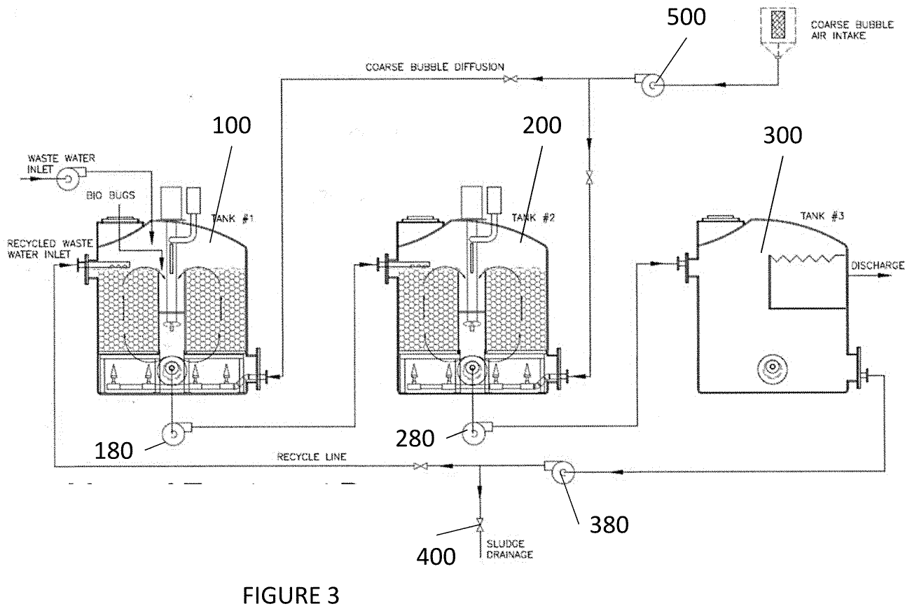

FIG. 3 illustrates a system of multiple treatment bio-reactors for treating wastewater effluent. As illustrated in FIG. 3, a first bio-reactor tank 100 treats wastewater effluent utilizing microorganisms in the same manner as the tank illustrated in FIG. 2.

The first bio-reactor tank 100 includes a packed media bed of small components. The small components provide a large surface area for the microorganisms to interact with the wastewater effluent being treated.

The microorganisms can be introduced at an upper volume of the first bio-reactor tank 100 through an opening. Moreover, fresh wastewater effluent can be introduced in upper volume of the first bio-reactor tank 100 via an inlet pump and/or valve.

An air pump provides air to a central volume of the first bio-reactor tank 100 so as to introduce bubbles into the wastewater effluent within the central volume of the first bio-reactor tank 100.

The air from the air pump may be is forced through a diffuser (not shown) that has openings so that the air is admitted into wastewater effluent within the central volume of the first bio-reactor tank 100 in the form of bubbles.

The bubbles can be further reduced in size by a propeller device which pushes the wastewater effluent within the central volume of the first bio-reactor tank 100 downward into a lower volume of the first bio-reactor tank 100.

With respect to the air being pumped by the air pump, the propeller device can also function as an aerator to aerate the wastewater effluent within the central volume of the first bio-reactor tank 100 with the air being introduced into the central volume of the first bio-reactor tank 100 by the first air pump.

The wastewater effluent within the central volume of the first bio-reactor tank 100 flows downward into a lower volume of the tank 100 and back up through the packed media bed of small components to create a flow of the wastewater effluent from the upper volume of the first bio-reactor tank 100, down through the central volume of the first bio-reactor tank 100, into a lower volume of the tank 100, and upward through the packed media bed of small components towards the upper volume of the first bio-reactor tank 100.

An air supply pump 500 pumps air into the lower volume of the first bio-reactor tank 100 via an air inlet and diffusers. The diffusers create bubbles to assist in moving the wastewater effluent upward through the packed media bed of small components towards the upper volume of the first bio-reactor tank 100.

It is noted that the diffusers may be angled towards the outer wall of the lower volume of the first bio-reactor tank 100 to create a flow near the outer wall to prevent or reduce pooling of the wastewater effluent near the outer wall.

In the lower volume, a portion of the wastewater effluent can be drained off and pumped by pump 180 to a second bio-reactor tank 200. The portion of the wastewater effluent drained off from the first bio-reactor tank 100 is introduced to an upper volume of the second bio-reactor tank 200.

In addition to the introduction of fresh wastewater effluent into the upper volume of the tank 100, recycled wastewater effluent from another tank is introduced in the upper volume of the tank 100 via a recycled wastewater effluent inlet. The recycled wastewater effluent, as illustrated, is effluent from a clarifier tank 300.

The second bio-reactor tank 200 includes a packed media bed of small components. The small components provide a large area for the microorganisms to interact with the wastewater effluent being treated.

An air pump provides air to a central volume of the second bio-reactor tank 200 so as to introduce bubbles into the wastewater effluent within the central volume of the tank 100.

The air from the air pump may be is forced through a diffuser (not shown) that has openings so that the air is admitted into wastewater effluent within the central volume of the second bio-reactor tank 200 in the form of bubbles.

The bubbles can be further reduced in size by a propeller device which pushes the wastewater effluent within the central volume of the second bio-reactor tank 200 downward into a lower volume of the second bio-reactor tank 200.

The bubbles can be further reduced in size by a propeller device which pushes the wastewater effluent within the central volume of the second bio-reactor tank 200 downward into a lower volume of the second bio-reactor tank 200.

The wastewater effluent within the central volume of the second bio-reactor tank 200 flows downward into a lower volume of the second bio-reactor tank 200 and back up through the packed media bed of small components to create a flow of the wastewater effluent from the upper volume of the second bio-reactor tank 200, down through the central volume of the second bio-reactor tank 200, into a lower volume of the second bio-reactor tank 200, and upward through the packed media bed of small components towards the upper volume of the second bio-reactor tank 200.

The air supply pump 500 pumps air into the lower volume of the second bio-reactor tank 200 via an air inlet and diffusers. The diffusers create bubbles to assist in moving the wastewater effluent upward through the packed media bed of small components towards the upper volume of the second bio-reactor tank 200.

It is noted that the diffusers may be angled towards the outer wall of the lower volume of the second bio-reactor tank 200 to create a flow near the outer wall to prevent or reduce pooling of the wastewater effluent near the outer wall.

In the lower volume, a portion of the wastewater effluent can be drained off and pumped by pump 280 to a third clarifier tank 300. The portion of the wastewater effluent drained off from the second bio-reactor tank 200 is introduced to an upper volume of the third clarifier tank 300.

Optionally, fresh wastewater effluent can be introduced into the upper volume of the second bio-reactor tank 200, as well as, microorganisms can be introduced into the upper volume of the second bio-reactor tank 200.

The third tank 300 is a clarifier tank that allows sloughed-off-sludge (biofilm) to settle out of the treated effluent so that a portion of the treated effluent can be discharged. The sloughed-off-sludge (biofilm) is recycled, via pump 380, back to the first tank 100 for further treatment.

By recycling the biofilm and some of the treated effluent, all or a significant portion of the microorganisms are not lost in the discharge process. This reduces the need to introduce new microorganisms into the first bio-reactor tank 100, as seed microorganism.

Moreover, the microorganism being recycled to the first bio-reactor tank 100 are mature, and thus, the microorganisms can process the wastewater effluent more effectively.

As illustrated in FIG. 3, the wastewater effluent passes through the first bio-reactor tank 100, the second bio-reactor tank 200, and the clarifier tank 300 before being discharged as treated effluent. Accumulated sloughed-off-sludge (biofilm) from the clarifier tank 300 is recycled back to the first bio-reactor tank 100 to enable further digesting of the remaining particles.

Carbon compounds in the wastewater effluent are digested by the microorganism and converted to carbon dioxide and water. Any remaining solids can be eventually removed through sludge drain 400 for additional processing or other uses.

Although FIG. 3 shows two bio-reactor tanks for microorganism digestion and a clarifier, the system may contain more than two bio-reactor tanks for microorganism digestion, wherein each bio-reactor tank is connected in a similar manner.

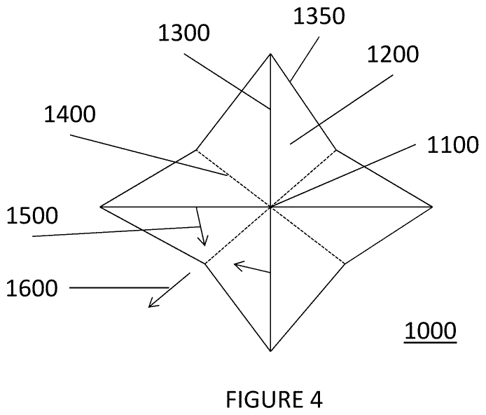

FIG. 4 shows a diversion member for diverting fluid to an outer edge of a non-round bio-reactor container. As illustrated in FIG. 4, a diversion member 1000 is located beneath the central volume of the bio-reactor tank so as to divert the downward flowing effluent towards the outer edges (walls) of the bio-reactor tank.

The diversion member 1000 includes a central peak 1100. The diversion member 1000 further includes projecting edges 1300 that extend from the central peak 1100 towards the outer edges (walls) of the bio-reactor tank. The projecting edges 1300 extend in a downward manner from the central peak 1100 to a floor of the bio-reactor tank.

The diversion member 1000 includes planar surfaces 1200, each having an edge which coincides with a projecting edge 1300. The planar surfaces 1200 slope downwardly from the projecting edge 1300 to a floor edge 1350.

As illustrated in FIG. 4, two planar surfaces 1200 are located between adjacent projecting edges 1300. The adjacent projecting edges 1300 may be orthogonal thereto.

The two planar surfaces 1200 located between adjacent projecting edges 1300 share a common edge 1400. The common edge 1400 slopes downwardly from the central peak 1100 to a floor.

As effluent encounters the diversion member 1000, the effluent flows down (1500) the planar surfaces 1200 and outwardly (1600) towards the outer edges (walls) of the bio-reactor tank.

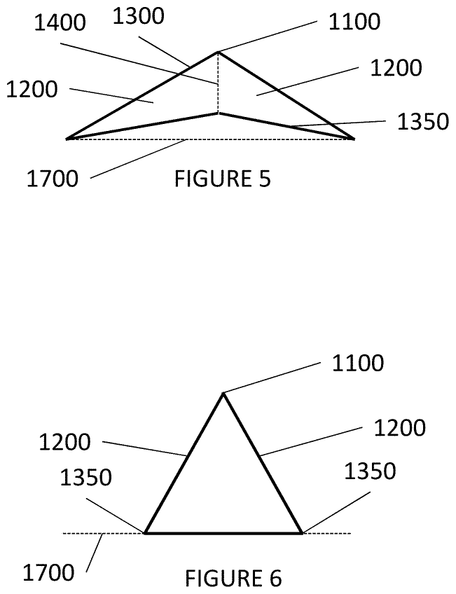

FIG. 5 shows a side view of the diversion member of FIG. 4. The diversion member 1000 includes planar surfaces 1200, each having an edge which coincides with a projecting edge 1300. The planar surfaces 1200 slope downwardly from the projecting edge 1300 a floor edge 1350 that meets a floor 1700.

As illustrated in FIG. 5, two planar surfaces 1200 located between adjacent projecting edges 1300 share a common edge 1400. The common edge 1400 slopes downwardly from the central peak 1100 to a floor 1700.

FIG. 6 shows a cross section of the diversion member of FIG. 4. The diversion member 1000 includes a central peak 1100 and planar surfaces 1200. The planar surfaces 1200 slope downwardly from the central peak 1100 to a floor edge 1350 that meets a floor 1700.

The diversion member 1000 of FIGS. 4-6 divert a portion of the effluent towards the outer edges of the bio-reactor tank to prevent sediment from collecting along the walls of the tank. Specifically, the diversion member 1000 of FIGS. 4-6 can be configured to divert a portion of the effluent towards the corners of a non-round bio-reactor tank to prevent sediment from collecting in the corners of a non-round bio-reactor tank.

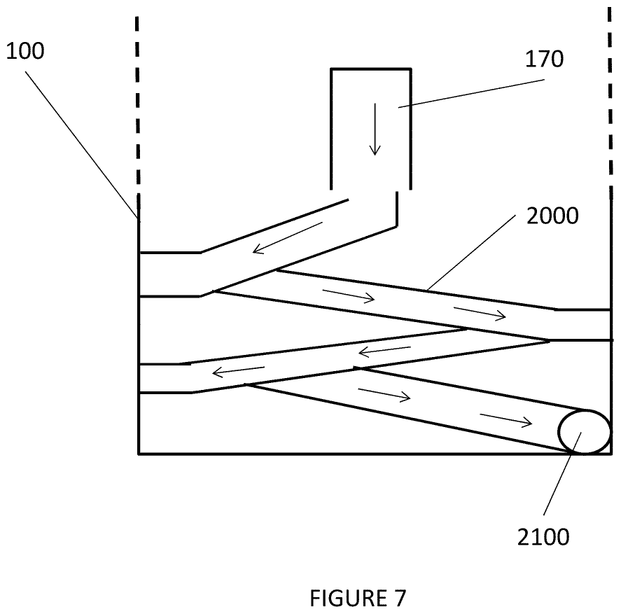

FIG. 7 shows a diversion member 2000 for diverting fluid in a rotational manner along an outer edge of a round bio-reactor container. As illustrated in FIG. 7, the diversion member 2000 may be a tube that is coiled so that the effluent is influenced to flow in a rotational manner so that as the effluent exits the diversion member 2000, the effluent flows along a wall of a round bio-reactor tank to prevent sediment from collecting along the walls of a round bio-reactor tank.

It is noted that although the diversion member is described as being located on or near the floor of a bio-reactor tank, the diversion member may be located anywhere in the effluent's flow path as the effluent leaves the central volume to enter the lower volume so long as the diversion member diverts a portion of the effluent towards the outer walls and/or corners of the bio-reactor tank to prevent build-up of sediment or particulate along the outer walls and/or in the corners of the bio-reactor tank.

As discussed above, the bio-reactor includes two distinct introductions of bubbles into the bio-reactor tank to provide oxygen to the microorganisms as well as to provide a force to cause the effluent to circulate within the bio-reactor tank. Bubbles are introduced within a central volume of the bio-reactor tank and propelled downward with effluent by a propeller mechanism to a lower volume of the bio-reactor tank. In the lower volume, additional bubbles are introduced to the “bubbled” effluent causing the bubbled effluent to flow upward through the packed media (housing the microorganism), before the effluent reaches an upper volume of the bio-reactor tank, where it cascades over the edge of the central volume and flows back towards the lower volume, completing the circulation path.

A portion of the effluent is “drained” off from the lower volume of the bio-reactor tank and pumped to an upper volume of a second bio-reactor tank. The second bio-reactor tank includes essentially the same components as the first bio-reactor tank.

A portion of the effluent in the second bio-reactor tank is “drained” off from the lower volume of the second bio-reactor tank and can be pumped to an upper volume of a clarifier tank for settling and discharge. The non-discharged effluent and remaining non-digested particulates in the clarifier tank are recycled back to the first bio-reactor tank and introduced into the upper volume of the first bio-reactor tank.

It is noted that more than two bio-reactor tanks can be chained together before the effluent is pumped into a clarifier tank for settling and discharge, wherein a portion of the effluent is drained off from a lower volume of a bio-reactor tank and pumped into an upper volume of the next bio-reactor tank.

As disclosed above, a bio-reactor for treating wastewater effluent using microorganisms, comprises a tank having a first volume, a second volume, and a third volume, each volume having an outer wall; an inlet in the first volume to introduce wastewater effluent; a central channel located within the second volume; a first air supply to introduce air into wastewater effluent located in the central channel within the second volume; a packed media bed of small components, the packed media bed being located in the second volume; a second air supply to introduce air into wastewater effluent located in the third volume to assist movement of wastewater effluent upward from the third volume, through the packed media bed, to the first volume; and an outlet in the third volume to drain a portion of the wastewater effluent.

The second air supply may include second air supply diffusers to introduce air bubbles into wastewater effluent located in the third volume. The first air supply may include first air supply diffusers to introduce air bubbles into wastewater effluent located in the central channel.

The bio-reactor may include a propulsion device in the central channel to propel wastewater effluent located in the central channel into the third volume. The propulsion device may reduce a size of the air bubbles in the wastewater effluent located in the central channel. The propulsion device may aerate the wastewater effluent located in the central channel.

The second air supply diffusers may be directed at the outer wall of the third volume to create wastewater effluent flow near the outer wall of the third volume to prevent or reduce pooling of wastewater effluent near the outer wall of the third volume.

The bio-reactor may include a diverter, located in the third volume to divert a portion of wastewater effluent flowing into the third volume from the central channel to the outer wall of the third volume to prevent build-up of particulate along the outer wall of the third volume.

A system for treating wastewater effluent using microorganisms, comprises a first bio-reactor; the first bio-reactor including, a tank having a first volume, a second volume, and a third volume, each volume having an outer wall, an inlet in the first volume to introduce wastewater effluent, a central channel located within the second volume, a first air supply to introduce air into wastewater effluent located in the central channel within the second volume, a packed media bed of small components, the packed media bed being located in the second volume, a second air supply to introduce air into wastewater effluent located in the third volume to assist movement of wastewater effluent upward from the third volume, through the packed media bed, to the first volume, and an outlet in the third volume to drain a portion of the wastewater effluent; and a second bio-reactor; the second bio-reactor including, a tank having a first volume, a second volume, and a third volume, each volume having an outer wall, an inlet in the first volume to introduce wastewater effluent, a central channel located within the second volume, a first air supply to introduce air into wastewater effluent located in the central channel within the second volume, a packed media bed of small components, the packed media bed being located in the second volume, a second air supply to introduce air into wastewater effluent located in the third volume to assist movement of wastewater effluent upward from the third volume, through the packed media bed, to the first volume, and an outlet in the third volume to drain a portion of the wastewater effluent; the outlet of the first bio-reactor being operatively connected to the inlet of the second bio-reactor.

The second air supply may include second air supply diffusers to introduce air bubbles into wastewater effluent located in the third volume. The first air supply may include first air supply diffusers to introduce air bubbles into wastewater effluent located in the central channel.

The bio-reactor may include a propulsion device in the central channel to propel wastewater effluent located in the central channel into the third volume. The propulsion device may aerate the wastewater effluent located in the central channel.

The second air supply diffusers may be directed at the outer wall of the third volume to create wastewater effluent flow near the outer wall of the third volume to prevent or reduce pooling of wastewater effluent near the outer wall of the third volume.

A diversion member for a bio-reactor for treating wastewater effluent using microorganisms, comprises a central peak; projecting edges extending from the central peak in a downward manner from the central peak; and planar surfaces sloping downwardly from the projecting edges, each planar surface having an edge coinciding with a projecting edge.

Two planar surfaces may be located between adjacent projecting edges. Adjacent projecting edges may be orthogonal.

The two planar surfaces may share a common edge, the common edge sloping downwardly from the central peak.

It will be appreciated that several of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above and the following claims.

What is claimed is:

1. A bio-reactor for treating wastewater effluent using microorganisms, comprising:
a tank having a first volume, a second volume, and a third volume, each volume having an outer wall;
an inlet in said first volume to introduce wastewater effluent;
a central channel located within said second volume;
a first air supply to introduce air into wastewater effluent located in said central channel within said second volume;
a packed media bed of small components, said packed media bed being located in said second volume;
a second air supply to introduce air into wastewater effluent located in said third volume to assist movement of wastewater effluent upward from said third volume, through said packed media bed, to said first volume; and
an outlet in said third volume to drain a portion of the wastewater effluent.

2. The bio-reactor, as claimed in claim 1, wherein said second air supply include second air supply diffusers to introduce air bubbles into wastewater effluent located in said third volume.

3. The bio-reactor, as claimed in claim 1, wherein said first air supply include first air supply diffusers to introduce air bubbles into wastewater effluent located in said central channel.

4. The bio-reactor, as claimed in claim 2, wherein said first air supply include first air supply diffusers to introduce air bubbles into wastewater effluent located in said central channel.

5. The bio-reactor, as claimed in claim 1, further comprising a propulsion device in said central channel to propel wastewater effluent located in said central channel into said third volume.

6. The bio-reactor, as claimed in claim 3, further comprising a propulsion device in said central channel to propel wastewater effluent located in said central channel into said third volume.

7. The bio-reactor, as claimed in claim 6, wherein said propulsion device reduces a size of the air bubbles in the wastewater effluent located in said central channel.

8. The bio-reactor, as claimed in claim 6, wherein said propulsion device aerates the wastewater effluent located in said central channel.

9. The bio-reactor, as claimed in claim 6, wherein said second air supply diffusers are directed at said outer wall of said third volume to create wastewater effluent flow near said outer wall of said third volume to prevent or reduce pooling of wastewater effluent near said outer wall of said third volume.

10. The bio-reactor, as claimed in claim 1, further comprising a diverter, located in said third volume to divert a portion of wastewater effluent flowing into said third volume from said central channel to said outer wall of said third volume to prevent build-up of particulate along said outer wall of said third volume.

11. A system for treating wastewater effluent using microorganisms, comprising:
a first bio-reactor;
said first bio-reactor including,
a tank having a first volume, a second volume, and a third volume,
each volume having an outer wall,
an inlet in said first volume to introduce wastewater effluent,
a central channel located within said second volume,
a first air supply to introduce air into wastewater effluent located in said central channel within said second volume,
a packed media bed of small components, said packed media bed being located in said second volume,
a second air supply to introduce air into wastewater effluent located in said third volume to assist movement of wastewater effluent upward from said third volume, through said packed media bed, to said first volume, and
an outlet in said third volume to drain a portion of the wastewater effluent; and
a second bio-reactor;
said second bio-reactor including,
a tank having a first volume, a second volume, and a third volume,
each volume having an outer wall,
an inlet in said first volume to introduce wastewater effluent,
a central channel located within said second volume,
a first air supply to introduce air into wastewater effluent located in said central channel within said second volume,
a packed media bed of small components, said packed media bed being located in said second volume,
a second air supply to introduce air into wastewater effluent located in said third volume to assist movement of wastewater effluent upward from said third volume, through said packed media bed, to said first volume, and
an outlet in said third volume to drain a portion of the wastewater effluent;
said outlet of said first bio-reactor being operatively connected to said inlet of said second bio-reactor.

12. The system, as claimed in claim 11, wherein said second air supply include second air supply diffusers to introduce air bubbles into wastewater effluent located in said third volume.

13. The system, as claimed in claim 11, wherein said first air supply include first air supply diffusers to introduce air bubbles into wastewater effluent located in said central channel.

14. The system, as claimed in claim 11, wherein each bio-reactor further comprises a propulsion device in said central channel to propel wastewater effluent located in said central channel into said third volume.

15. The system, as claimed in claim 14, wherein said propulsion device aerates the wastewater effluent located in said central channel.

16. The system, as claimed in claim 12, wherein said second air supply diffusers are directed at said outer wall of said third volume to create wastewater effluent flow near said outer wall of said third volume to prevent or reduce pooling of wastewater effluent near said outer wall of said third volume.

17. A diversion member for a bio-reactor for treating wastewater effluent using microorganisms, comprising:
a central peak;
projecting edges extending from said central peak in a downward manner from said central peak; and
planar surfaces sloping downwardly from said projecting edges, each planar surface having an edge coinciding with a projecting edge.

18. The diversion member, as claimed in claim 17, wherein two planar surfaces are located between adjacent projecting edges.

19. The diversion member, as claimed in claim 18, wherein adjacent projecting edges are orthogonal.

20. The diversion member, as claimed in claim 18, wherein said two planar surfaces share a common edge, said common edge sloping downwardly from said central peak.
